(19) United States
(12) Patent Application Publication
(10) Pub. No.: US 2010/0003577 A1
(43) Pub. Date: Jan. 7, 2010

(54) Fuel gas supplying apparatus for fuel cell system

(76) Inventors: Tohru Eguchi, Shizuoka-ken (JP); Kazuyuki Hirota, Shizuoka-ken (JP)

Correspondence Address: FLYNN THIEL BOUTELL & TANIS, P.C., 2026 RAMBLING ROAD, KALAMAZOO, MI, 49008-1631, US

(21) Appl. No.: 12/459,622

(22) Filed: Jul. 2, 2009

(30) Foreign Application Priority Data
Jul. 4, 2008 (JP) 2008-175259
Jul. 4, 2008 (JP) 2008-175260

(51) Int. Cl. H01M 8/04

(52) U.S. Cl. 429/34

(57) ABSTRACT

A fuel gas supplying apparatus for a fuel cell system includes an exhaust apparatus having an exhaust pipe; a fuel apparatus for supplying fuel to the fuel cell; a regulator arranged to reduce pressure of the fuel gas provided to the fuel cell; and a fuel gas emitting pipe confluence-connected to the exhaust pipe, to emit fuel gas to an outside of the fuel apparatus by using the exhaust pipe as a pipe for temporarily emitting gas to the atmosphere. The regulator includes a plurality of pressure relief valves, a pressure reducing portion, and a solenoid valve upstream of the pressure reducing portion. The pressure relief valves are connected upstream and downstream of the pressure reducing portion.

### FIELD OF THE INVENTION

The invention relates to a fuel gas supplying apparatus of a fuel cell system and, more particularly, to a fuel gas supplying apparatus of a fuel cell system for reducing a pressure of a fuel gas stored in a fuel tank at a high pressure and supplying the reduced fuel gas to a fuel cell.

### BACKGROUND OF THE INVENTION

In a vehicle such as electric vehicle, hybrid vehicle, or the like, a fuel cell system having a fuel cell (also referred to as “stack”) serving as a motive power source is installed. In the case of supplying pure hydrogen as a fuel gas into the fuel cell, a function for emitting a hydrogen gas to the outside of a fuel apparatus is provided. Such a function is mainly classified into a purge and an emergency emission and their objects and roles differ.

As shown in FIG. 5, in a fuel cell system 101, as a regulator 106 for reducing a pressure of a fuel gas, a primary regulator 108 having a primary pressure reducing portion 107 and a secondary regulator 110 having a secondary pressure reducing portion 109 are sequentially provided (on a fuel tank 103 side) for a fuel supplying pipe 105 between a fuel cell 102 and a valve 104 of the fuel tank 103. A PRD (Pressure Relief Device) pipe 111 functioning as a relief valve in order to release the fuel gas in the fuel tank 103 when a temperature in the fuel tank 103 becomes abnormal is released to the atmosphere and connected to the valve 104 of the fuel tank 103. A primary atmospheric pressure reference tube 112 is released to the atmosphere and connected to the primary regulator 108. A secondary atmospheric pressure reference tube 113 is released to the atmosphere and connected to the secondary regulator 110. On an upstream side of the secondary pressure reducing portion 109, an upstream side pressure relief pipe 114 of a high pressure is released to the atmosphere and connected to the secondary regulator 110. On a downstream side of the secondary pressure reducing portion 109, a downstream side pressure relief pipe 115 of a low pressure is released to the atmosphere and connected to the secondary regulator 110. An exhaust pipe 116 for emitting the air (off-gas) is connected to the fuel cell 102.

Thus, in the fuel cell system 101, the fuel gas is emitted from the PRD pipe 111, primary atmospheric pressure reference tube 112, secondary atmospheric pressure reference tube 113, upstream side pressure relief pipe 114, and downstream side pressure relief pipe 115 in accordance with circumstances. The PRD pipe 111 is provided mainly to improve a using efficiency of the fuel cell 102 and is used to release the internal fuel gas when a temperature in the fuel tank 103 becomes the abnormal temperature. Since the fuel gas is emitted in a state where an inner pressure has been applied, a large amount of powerful fuel gas is emitted (purged). The primary atmospheric pressure reference tube 112 and the secondary atmospheric pressure reference tube 113 are controlled by the primary regulator 108 and the secondary regulator 110 by a gauge pressure, respectively, and fetch the atmospheric pressure for reference. However, a small amount of hydrogen is always emitted in terms of their structure. When an abnormal pressure is applied to the secondary regulator 110, the upstream side pressure relief pipe 114 and the downstream side pressure relief pipe 115 emit the fuel gas. That is, only when an abnormality occurs, they operate and emit a certain amount of powerful gas.

Attention is now paid to the case of emergency emitting of the hydrogen gas. In the case of the emergency emission, there are different reduction ratios (levels) depending on the contents of the abnormality of the fuel cell system 101 as mentioned above.

In the related art, among the fuel cell systems, there is a system constructed in such a manner that an outside-guiding valve is attached to the fuel gas tank side than a reduction valve, the fuel gas is emitted through the outside-guiding valve, and as a pipe connecting the reduction valve and the fuel cell, a pipe whose strength is smaller than such a strength that can endure the fuel gas is used, thereby realizing a light weight and making the pipe to be easily installed.

Among mobiles in which a fuel cell for generating an electricity from the fuel gas and a gas oxide is mounted, there is a mobile in which a gas pressure of fuel gas supplying means for supplying the fuel gas to the fuel cell is used as a driving source of the load apparatus.

Related art includes JP-A-2006-331781 and JP-A-2005-339862. In the fuel cell system in the related art, when the hydrogen gas is emergently emitted, the fuel gas is emitted as it is from each pipe to the atmosphere. However, since there is a case where a certain amount of fuel gas is emitted in accordance with circumstances, it is improper to directly emit all of the fuel gas to the atmosphere and it is demanded to improve such a situation.

As shown in FIG. 6, in the case where the system is improved so as not to directly emit the fuel gas to the atmosphere and the upstream side pressure relief pipe 114 and the downstream side pressure relief pipe 115 are independently confluence-connected to the exhaust pipe 116, respectively, there is such an inconvenience that the number of sound source portions in the exhaust pipe 116 increases and an exhaust sound increases and becomes noises.

In the case of supplying pure hydrogen as a fuel gas into the fuel cell, a pressure of the fuel gas is reduced to a desired pressure by a regulator and the reduced gas is supplied to an anode side of the fuel cell. Since a fuel tank has been filled with the fuel gas in a high pressure state, when the pressure of the fuel gas is reduced by the regulator, it is reduced to multi levels. A solenoid valve (injector, shut-off valve, or the like) for controlling a circulation shut-off state of the fuel gas and a pressure relief valve which operates in an inconvenient state or an abnormal state such as a high pressure state of the fuel gas on a passage of a fuel supplying pipe are provided on the passage.

In another fuel cell system in the related art, when the regulator is set, the following procedure is taken: that is, first, a pressure reduction ratio (level) of the regulator is set, cross sectional areas of front and rear passages constructing the regulator are determined, and subsequently, an operating pressure of the pressure relief valve is determined in accordance with a pressure on the upstream side and a pressure on the downstream side before and after the pressure reduction. At this time, a position on the passage of each of the solenoid valve and the pressure relief valve is arbitrarily decided.

However, there is such an inconvenience that even after the solenoid valve was closed, it is difficult to perfectly seal the regulator in terms of a structure of the regulator, a creep phenomenon in which a hydrogen gas flows to the downstream side occurs, the pressure on the downstream side rises, and when the pressure of the pressure relief valve rises to a predetermined value or more, the hydrogen gas which ought to be inherently supplied to the fuel cell from the pressure relief valve is wastefully emitted.

One object of the invention is to provide a fuel gas supplying apparatus of a fuel cell system in which such an operation that a fuel gas is emitted under a vehicle floor near a center of a vehicle is eliminated and an exhaust pipe serving as a pipe necessary for a function of the fuel cell system is used, thereby simplifying the whole pipe layout. Another object of the invention is to provide a fuel gas supplying apparatus of a fuel cell system in which the number of opportunities at which a function for emitting a fuel gas component is wastefully made operative is reduced, a large saving space and a high mountability are obtained, the number of attention items in an assembly (pipe layout) of the fuel supplying pipe is reduced, and its difficulty is decreased.

### SUMMARY OF THE INVENTION

According to one embodiment of the invention, there is provided a fuel gas supplying apparatus of a fuel cell system comprising: a fuel cell for supplying air containing oxygen to a cathode, supplying a fuel gas containing hydrogen to an anode, and executing a power generation; an exhausting apparatus having a muffler in an exhaust pipe on a downstream side of the fuel cell; a fuel apparatus having a fuel supplying pipe for supplying the fuel gas to the fuel cell and a regulator which is arranged on the way of the fuel supplying pipe and reduces a pressure of the fuel gas; and a fuel gas emitting pipe which can emit the fuel gas in the fuel supplying pipe to an outside of the fuel apparatus, wherein the fuel gas emitting pipe is confluence-connected to the exhaust pipe, thereby enabling the fuel gas in the fuel supplying pipe to be temporarily emitted to the atmosphere through the fuel gas emitting pipe and the exhaust pipe.

According to the fuel gas supplying apparatus of the fuel cell system of one embodiment of the invention, the fuel gas is not emitted under the vehicle floor near the center of the vehicle and the whole pipe layout can be simplified.

In another embodiment of the invention, the object for eliminating such an operation that the fuel gas is emitted under the vehicle floor near the center of the vehicle and simplifying the whole pipe layout is realized by using the exhaust pipe serving as a pipe necessary for a function of the fuel cell system.

According to another embodiment of the invention, there is provided a fuel gas supplying apparatus of a fuel cell system comprising: a fuel cell for supplying air containing oxygen to a cathode, supplying a fuel gas containing hydrogen to an anode, and executing a power generation; an exhaust apparatus having a muffler in an exhaust pipe on a downstream side of the fuel cell; and a fuel apparatus having a fuel supply pipe for supplying the fuel gas to the fuel cell. A regulator includes a regulator pressure reducing portion for reducing a pressure of the fuel gas, a solenoid valve for controlling a shut-off of circulation of the fuel gas, and a pressure relief valve for emitting the fuel gas to an outside of the fuel apparatus arranged on a passage of the fuel supply pipe, wherein the solenoid valve and a plurality of pressure relief valves are integratedly provided for the regulator having the regulator pressure reducing portion. The solenoid valve is provided on an upstream side fuel gas passage from the regulator pressure reducing portion, one of the pressure relief valves is connected to the upstream side fuel gas passage of the regulator pressure reducing portion, and the other pressure relief valve is connected to a downstream side fuel gas passage of the regulator pressure reducing portion.

According to the fuel gas supplying apparatus of the fuel cell system of another embodiment of the invention, the number of opportunities at which a function for emitting a fuel gas component is wastefully made operative is reduced, a large saving space and a high mountability are obtained, and assembly (pipe layout) of the fuel supply pipe can be easily performed.

### BRIEF DESCRIPTION OF THE DRAWINGS

FIG. 1 is a schematic constructional diagram of a fuel gas supplying apparatus of a fuel cell system.

FIG. 2 is a perspective view of an exhaust pipe assembly.

FIG. 3 is a perspective view of a tank unit mounted on a subframe when seen from the downward direction.

FIG. 4 is a schematic constructional diagram of the fuel cell system.

FIG. 5 is a first schematic constructional diagram of a fuel gas supplying apparatus of a fuel cell system in the related art.

FIG. 6 is a second schematic constructional diagram of the fuel gas supplying apparatus of the fuel cell system in the related art.

FIG. 7 is a constructional diagram of a secondary regulator of an embodiment of a fuel cell system.

FIG. 8 is a constructional diagram of a fuel apparatus of the fuel cell system.

FIG. 9 is a schematic constructional diagram of an embodiment of the fuel cell system.

Embodiments of the invention will be described in detail and specifically hereinbelow with reference to the drawings.

### DETAILED DESCRIPTION OF THE INVENTION

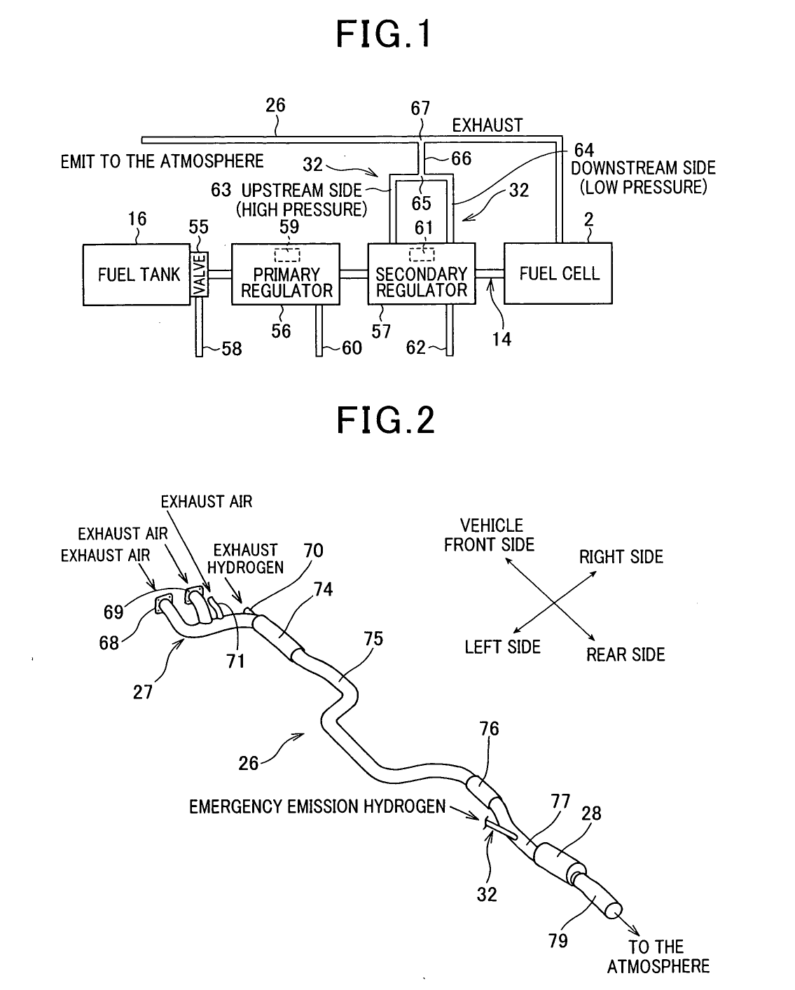

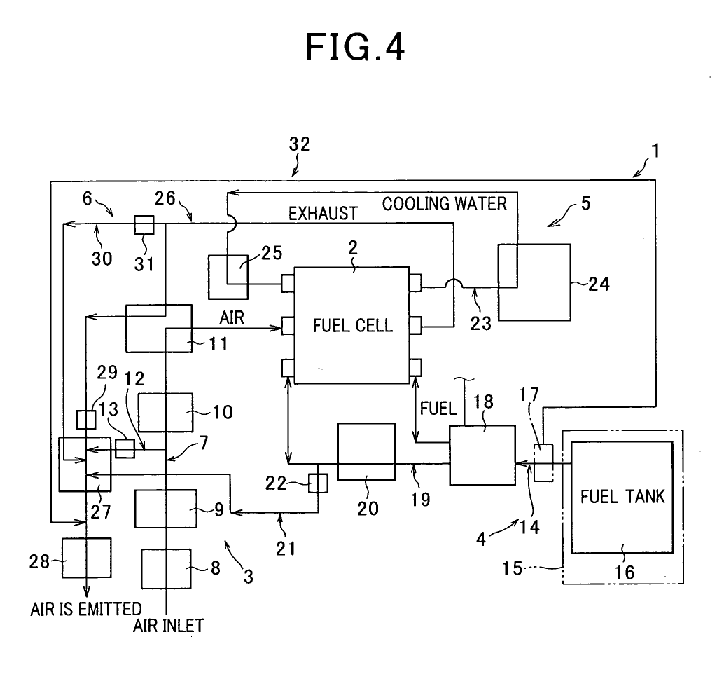

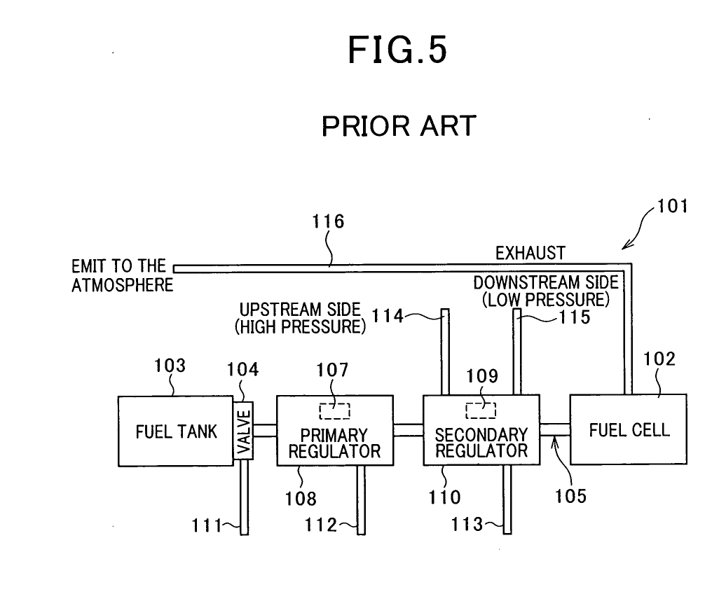

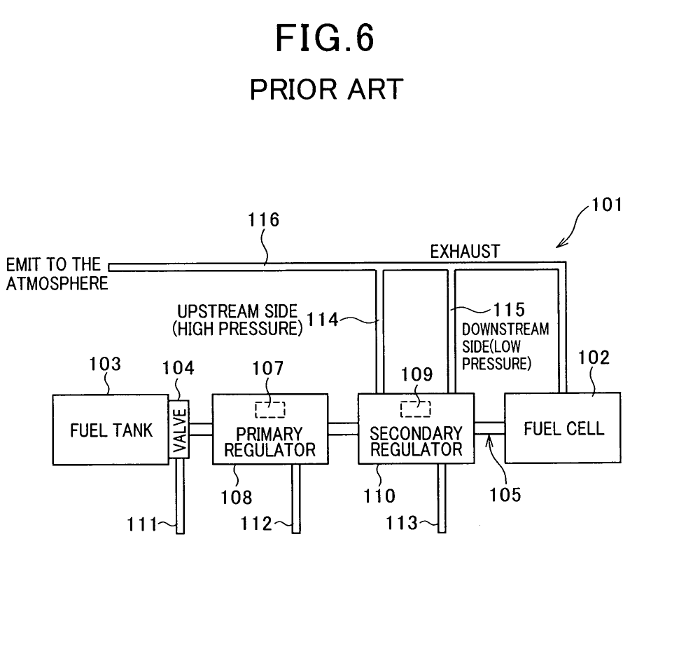

FIGS. 1 to 4 illustrate one embodiment of the invention. In FIG. 4, reference numeral 1 denotes a fuel cell system which is installed in a fuel cell vehicle (hereinbelow, simply referred to as a “vehicle”).

As shown in FIG. 4, the fuel cell system 1 has a fuel cell (stack) 2 for receiving air containing oxygen at a cathode, receiving a fuel gas containing hydrogen at an anode, and executing a power generation.

The fuel cell system 1 has: an air apparatus 3 of an air supplying system for supplying air on the upstream side of the fuel cell 2; a fuel apparatus 4 of a fuel supply system for supplying a fuel gas to the fuel cell 2; a cooling apparatus 5 of a cooling system for cooling the fuel cell 2 to a proper temperature; and an exhaust apparatus 6 of an exhaust system for exhausting the air (off-gas) on the downstream side of the fuel cell 2.

In the air apparatus 3, an air supply pipe 7 is connected to the fuel cell 2. The following devices are provided for the air supply pipe 7 in order from the side of an air inlet: an air filter 8 for purifying the air from the air inlet; an air compressor 9 for bringing in the air, pressurizing it to about several atmospheric pressure, and feeding to the fuel cell 2 side; a heat exchanger 10 for adjusting the air to such a temperature that a high power generation efficiency is obtained; and a humidifier 11 for adjusting the air to such humidity that the high power generation efficiency is obtained.

An air bypass pipe 12 is connected to the air supply pipe 7 between the air compressor 9 and the heat exchanger 10. The air bypass pipe 12 has an air shut-off valve 13 and a front edge is connected to a manifold 27, which will be explained hereinafter. Each of the air supply pipe 7 and the air bypass pipe 12 has a relatively large cross sectional area.

The air compressor 9 has a centrifugal fan such as a turbo compressor and can be driven by an electric motor at a rotational speed of 0 to tens of thousands rpm. Upon driving the air compressor 9, although a pulsation is relatively small, a wind-cutting sound of a high frequency is generated.

Although the air from the air compressor 9 is fed to the cathode side of the fuel cell 2, a part of the air is exhausted by being bypassed from the air bypass pipe 12 without passing through the fuel cell 2. Thus, a flow rate of the air which flows into the cathode side of the fuel cell 2 is adjusted. The air which is fed to the cathode side of the fuel cell 2 is adjusted to a temperature at which high power generation efficiency is obtained by passing through the heat exchanger 10. After that, the air is humidified by the humidifier 11 so as to obtain a high conversion efficiency by a flowability of ions and is fed to the cathode side of the fuel cell 2. In the fuel cell 2, the fed air is distributed and supplied to a number of cells (not shown) by an internal manifold structure. In some embodiments, the fuel cell includes almost an infinite number of cells. After air passes through each cell, the air is emitted to the outside of the fuel cell 2 from the exhaust apparatus 6.

In the fuel apparatus 4, a fuel tank 16 of a tank unit 15 for storing the fuel gas is connected to the fuel cell 2 through a fuel supply pipe 14. A regulator (pressure reducing valve) 17 for reducing a pressure of the fuel gas supplied to the fuel cell 2 and a flow rate adjusting injector (adjusting solenoid valve, shut-off valve or the like) 18 communicate with control means provided for the fuel supply pipe 14 in order to control fuel from the fuel tank 16 side.

A fuel branching pipe 19 coupled with the fuel cell 2 is connected to the flow rate adjusting injector (such as an adjusting solenoid valve) 18 by a path different from that of the fuel supply pipe 14 so as to construct pipes of two systems. A steam separator 20 for separating a gas and a liquid is provided for the fuel branching pipe 19.

The flow rate adjusting injector or adjusting solenoid valve 18 alternately supplies the fuel gas to the fuel supply pipe 14 and the fuel branching pipe 19 on the fuel cell 2 side at a predetermined interval, thereby making a hydrogen circulating pump unnecessary, providing a uniform hydrogen concentration, and draining the production water.

A purge pipe 21 serving as a hydrogen emitting pipe is connected to the fuel branching pipe 19 on the fuel cell 2 side through the steam separator 20. In the case where impurities or the like have been accumulated in hydrogen, the purge pipe 21 executes a hydrogen purge for temporarily emitting (purging) such hydrogen. The purge pipe 21 has a purge shut-off valve 22. A front edge of the purge pipe 21 is connected to the manifold 27, which will be explained hereinafter. The purge pipe 21 also functions as a pipe which is connected to the anode side of the fuel cell 2 and allows the anode off-gas for emitting the used fuel gas to flow.

In the fuel apparatus 4, when hydrogen is supplied into the fuel cell 2, in order to raise its efficiency, by driving the flow rate adjusting injector, (such as an adjusting-solenoid valve) 18, hydrogen is fed to the fuel supply pipe 14 and the fuel branching pipe 19 of the two systems for communicating with one or more outlets/inlets of an anode side of the fuel cell 2 so as to be alternately distributed to the outlets/inlets at a predetermined interval and hydrogen is reciprocatively supplied by using a pressure gradient. The purge shut-off valve 22 of the purge pipe 21 shuts off a flow of the purge gas in which the production water is also contained or, contrarily, shuts off a backward flow from the downstream side. In the fuel apparatus 4, by controlling timing for driving the flow rate adjusting injector 18, timing for driving the purge shut-off valve 22, and the like, both uniformity of hydrogen concentration and a drain of the production water are satisfied, thereby accomplishing a high efficiency.

It is an object of the purge hydrogen to keep the high conversion efficiency of the fuel cell 2 or prevent the interpole differential pressure between the cathode and the anode of the fuel cell 2 from becoming excessive at the time of the vehicle stop or the like. There is also a case that when an abnormality has occurred in the fuel apparatus 4, the fuel gas is emergency emitted to the outside of the vehicle. As a function for emitting the hydrogen gas to the outside of the fuel apparatus 4, there are a purge and an emergency emission and their objects and roles are different, respectively.

In the cooling apparatus 5, a coolant pipe 23 for circulating a coolant is connected to the fuel cell 2. A radiator 24 for cooling the coolant at a high temperature which is fed from the fuel cell 2 and a pump 25 for circulating the cooled coolant to the fuel cell 2 are provided in series with the coolant pipe 23 to provide a flowing direction for the coolant. Thus, the fuel cell 2 is always held within a temperature range for high power generation efficiency upon driving of the special coolant which takes a mixture of ions or the like into consideration.

In the exhaust apparatus 6, an exhaust pipe 26 is connected to the cathode side of the fuel cell 2 and emits the used air (cathode off-gas) from the fuel cell 2.

The exhaust pipe 26 is provided to humidify the dry air at the inlet by the water generated by the fuel cell 2, that is, to use the moisture (production water or the like) contained in the air (off-gas). The exhaust pipe 26 passes through the humidifier 11 and is arranged so as to feed a part of the air to the humidifier 11. The exhaust pipe 26 connects with a manifold 27 and a muffler 28 disposed on the downstream side of the manifold 27. The exhaust pipe 26 has a first exhaust shut-off valve 29 between the humidifier 11 and the manifold 27.

On the upstream side of the humidifier 11, one end of an exhaust bypass pipe 30 is connected to the exhaust pipe 26. In order to adjust a humidification amount, the exhaust bypass pipe 30 emits the air which does not pass through the humidifier 11 to the manifold 27. The exhaust bypass pipe 30 has a second exhaust shut-off valve 31 and the other end, such as a front edge, is connected to the manifold 27. That is, the exhaust bypass pipe 30 emits a part of the emission air to the manifold 27 without passing through the humidifier 11 for the purpose of adjusting the gas flow rate so as to adjust an amount of moisture which is used for humidification. The exhaust bypass pipe 30 is formed in a path whose cross sectional area is smaller than that of the exhaust pipe 26 which passes through the humidifier 11.

Therefore, the air (off-gas) from the exhaust pipe 26 and the air (off-gas) from the exhaust bypass pipe 30 are joined again by the manifold 27 and emitted together with the moisture and the like. A part of the air which is emitted from the air bypass pipe 12 without passing through the fuel cell 2 and purged hydrogen from the hydrogen emitting purge pipe 21 are provided to the manifold 27 together with the air from the exhaust pipe 26 and the exhaust bypass pipe 30.

Between the manifold 27 and the muffler 28, a fuel gas emitting pipe (emergency hydrogen emitting pipe) 32 coupled with the regulator 17 is confluence-connected to the exhaust pipe 26. The fuel gas emitting pipe 32 can emit the fuel gas in the fuel supply pipe 14 to the outside of the fuel apparatus 4. Thus, the fuel gas in the fuel supply pipe 14 can be temporarily emitted to the atmosphere through the fuel gas emitting pipe 32 and the exhaust pipe 26. Thus it is possible to prevent the fuel gas from the fuel apparatus 4 side from being directly emitted to the atmosphere.

The conversion efficiency of the fuel cell 2 changes due to the occurrence of such a phenomenon that a cell voltage of the fuel cell 2 drops during the vehicle running, idling stop, or the like. One of the reasons for such a phenomenon is that since the fuel gas which is supplied is humidified or the production water is generated by the reaction, their condensation water remains in the fuel cell 2 and power of the fuel cell 2 decreases. Therefore, a gas flow by the purge is used in order to eject the condensation water to the outside of the fuel system. This is also because if the residence or accumulation is continued for a long time by circulating the fuel gas or the like, a transmission gas of N₂ (nitrogen) from the cathode is liable to be accumulated in the anode system and obstructs the reaction. It is, therefore, necessary to emit the transmission N₂ gas in order to recover the fuel cell 2.

As for combustion characteristics of the fuel gas, when a capacity hydrogen concentration exceeds 4%, it becomes combustible and when the capacity hydrogen concentration exceeds about 18%, instantaneous and explosive combustion occurs. Therefore, in the case of using hydrogen for a fuel gas of the fuel cell 2, it is required that the capacity hydrogen concentration of the emission gas at the time of ejecting purge hydrogen is set to 4% or less in consideration of various external environments.

Although moisture is produced by the reaction of the fuel cell 2, in order to raise power generation efficiency of the fuel cell 2 by a flowability of ions, the supply gas, that is, the air and hydrogen (fuel gas) are humidified. In such a case, since not only the production water generated by the reaction but also the moisture due to the humidification is contained, a quantity of the moisture in the emission gas increases relatively. The production water and hydrogen gas emitted into the exhaust pipe 26 in this manner flow in the exhaust pipe 26 together with other gases.

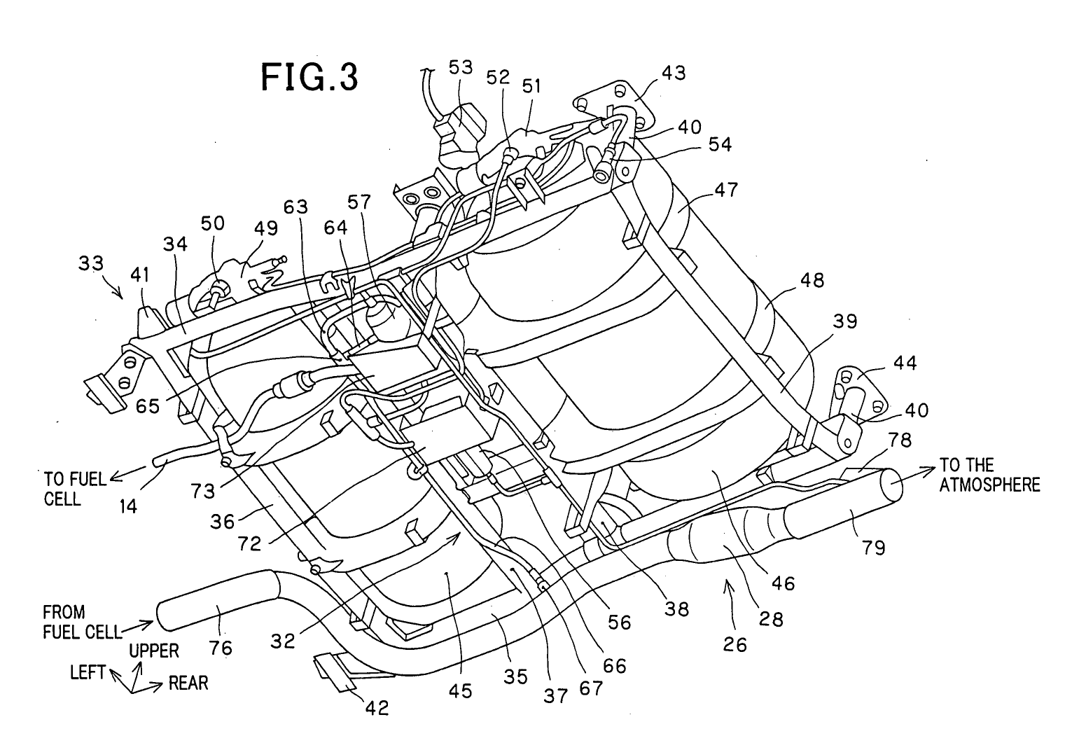

In the fuel apparatus 4, the tank unit 15 having the fuel tank 16 is disposed on a subframe (tank frame) 33 in a vehicle rear portion as shown in FIG. 3.

The subframe 33 is constructed in an almost rectangular shape by integratedly assembling: a left-side frame 34 and a right-side frame 35 which extend in the vehicle front/rear direction; and first to fourth cross members 36, 37, 38, and 39 which extend in the vehicle width direction between the left-side frame 34 and the right-side frame 35 and which are arranged in order from the vehicle front side toward the vehicle rear side at a predetermined interval. After the subframe 33 is mounted to the vehicle floor side, it is strictly coupled with the vehicle body by a left-front floor supporting portion 41, a right-front floor supporting portion 42, a left-rear floor supporting portion 43, and a right-rear floor supporting portion 44, each having a pedestal portion 40.

The tank unit 15 has a front-side fuel tank 45 and a rear-side fuel tank 46, which combined, form a fuel tank 16. The front-side fuel tank 45 and the rear-side fuel tank 46 extend in the vehicle width direction and are arranged so as to be away from each other in the vehicle front/rear direction. The front-side fuel tank 45 is supported by the first and second cross members 36 and 37. The rear-side fuel tank 46 is supported by the third and fourth cross members 38 and 39. The rear-side fuel tank 46 is constructed so as to be larger than the front-side fuel tank 45. That is, the small front-side fuel tank 45 having a small cross sectional area is arranged on the front side corresponding to a vehicle body floor of a passenger room. The large rear-side fuel tank 46 having a large cross sectional area is arranged on the rear side corresponding to a vehicle body floor of a luggage compartment. A pair of rear wheels of the vehicle are arranged on both outsides of the front-side fuel tank 45 and the rear-side fuel tank 46 so as to be partially overlaid.

The front-side fuel tank 45 and the rear-side fuel tank 46 are strictly fixed to the subframe 33 through a left structure member 47 and a right structure member 48 which extend in the vehicle front/rear direction and in which middle abdominal portions are coupled.

Each of the front-side fuel tank 45 and the rear-side fuel tank 46 has a fundamental height in dependence on its circular cross sectional shape. An upper surface height of the portion where the regulator 17 is arranged in a space between the front-side fuel tank 45 and the rear-side fuel tank 46 is relatively low. Therefore, an extending member in the width direction of the rear suspension is arranged in such a portion., thereby assuring a stroke of the rear suspension extending in the width direction. Thus, such a construction is excellent in ensuring running performance of the vehicle. Since the front-side fuel tank 45 and the rear-side fuel tank 46, as heavy structures can be mounted at low positions, stability of the vehicle position can be assured. It is preferable that a center portion of the lower surface of the vehicle body floor is covered with an under cover within a range from the front side toward the rear side. Consequently, all of the accessories, pipes, and fuel system assemblies which are necessary when constructing the fuel cell system 1 can be protected against stepping-stones, submersion, or the like. That is, the rear suspension is arranged between the upper surface side of the subframe 33 and the front-side fuel tank 45, rear-side fuel tank 46, and fuel supplying pipe 14 which have been assembled to the subframe 33 and the lower surface of the vehicle body floor. Since the rear suspension operates as a link mechanism so as to swing vertically, the space is formed in consideration of its locus. The rear suspension is supported to the vehicle body at both of the right and left outside positions of the subframe 33. A center of gravity of the fuel system as a heavy structure can be set to a lower position while assuring the stroke of the rear suspension. A center of gravity of the vehicle and a height of a floor surface in the passenger room can be also suppressed and thus provided at lower positions with respect to the ground. Since the subframe 33 is not integrated with a rear suspension frame, when the front-side fuel tank 45 and the rear-side fuel tank 46 are removed, there is no need to also remove a suspension system, such as a rear suspension and the like, and thus maintainability and ease of replacement is improved.

The fuel supplying system including the front-side fuel tank 45 and the rear-side fuel tank 46 is assembled and mounted onto the subframe 33. A lower surface of the front portion of the subframe 33 is fixed to the vehicle body floor so as to form an almost flush surface with the lower surface of the vehicle body floor of the passenger room. Since the lower surface of the whole subframe 33 is almost horizontal so as to be parallel with the ground, in a rear portion of the subframe 33, two pairs of right and left pedestal portions 40 for coupling with the vehicle body floor are provided so as to be arranged in the vehicle front/rear direction. The subframe 33 is disposed downwardly away from the vehicle body floor so as to form a space where the exhaust pipe 26 and the like can be enclosed when the subframe 33 is mounted to the vehicle. A flat cover is attached to a pedestal in such a manner that the lower surface of the subframe 33 is covered with the flat cover.

As illustrated in FIG. 3, the front-side fuel tank 45 has a front-side valve 49 and a front-side nozzle 50 as a valve for emergency hydrogen emission at a left edge. The rear-side fuel tank 46 has a rear-side valve 51, a rear-side nozzle 52 as a valve for emergency hydrogen emission, a filter 53, and a defuel coupler 54 at a left edge. That is, the front-side valve 49 and the rear-side valve 51 have openings adapted to take in or take out the fuel gas and are concentratedly provided around the left-side frame 34 corresponding to one side of the subframe 33 together with other pipes. That is, they are arranged on the left-side frame 34 corresponding to the vehicle opposite side away from the right-side frame 35 where the exhaust pipe 26 is assembled.

In one embodiment, the independent front-side nozzle 50 and rear-side nozzle 52 operate as PRD (Pressure Relief Device) pipes functioning as relief valves in order to release the fuel gas in the fuel tank during a state of a higher emergency degree. That is, when a temperature in the fuel tank 16 (45, 46) becomes abnormal, the relief valves integratedly provided for the front-side valve 49 and the rear-side valve 51, open respectively. If the front-side nozzle 50 and the rear-side nozzle 52 are made operative, the high pressure hydrogen gas is emitted when it is at the high pressure.

In another embodiment, the independent front-side nozzle 50 and rear-side nozzle 52, which operate in a state of a high emergency degree, are integratedly provided for the front-side valve 49 and the rear-side valve 51, respectively. If the front-side nozzle 50 and the rear-side nozzle 52 are made operative, the high pressure hydrogen gas is emitted.

In the embodiment of the fuel apparatus 4 shown in FIG. 1, a plurality of (two) primary regulator (such as high pressure reducing valves) 56 and secondary regulator 57 are provided as a regulator 17 (56, 57) for the fuel supply pipe 14 in order from a valve 55 side of the fuel tank 16 in such a manner that the pressure of the fuel gas on the way to the fuel supply pipe 14 is reduced to a plurality of levels, thereby reducing the pressure of the fuel gas through the multi levels. In this case, between the primary regulator 56 and the secondary regulator 57, the low-pressure side regulator in which the pressure of the fuel gas is lower is the secondary regulator 57.

In the primary regulator 56 and the secondary regulator 57, the high pressure hydrogen gas (for example, about maximum 300 to 700 atmospheric pressure) taken out of the front-side fuel tank 45 and the rear-side fuel tank 46 is, first, introduced by the joined pipe to the primary regulator 56 attached near the center in the vehicle width direction, is remarkably reduced in pressure, and is taken out at tens of atmospheric pressure (for example, about 20 atmospheric pressure). Subsequently, as shown in FIG. 3, the hydrogen gas is introduced to the secondary regulator 57 existing on the side of the front-side fuel tank 45 and the rear-side fuel tank 46 (on the valve side of the tank unit 15), is secondarily pressure reduced, is taken out at a few atmospheric pressure (for example, about 4 to 8 atmospheric pressure), and is supplied to the fuel cell 2 side.

As shown in FIG. 3, in such a structure the primary and secondary regulators 56 and 57, which are used in common for the front-side fuel tank 45 and the rear-side fuel tank 46, are arranged supported between the front-side fuel tank 45 and the rear-side fuel tank 46, which is preferable from a viewpoint of the pipe layout.

As shown in FIG. 1, a PRD pipe 58 as a front-side nozzle 50 and a rear-side nozzle 52 for emergency emitting of fuel gas is connected to the valve (corresponding to the front-side valve 49 of the front-side fuel tank 45 and the rear-side valve 51 of the rear-side fuel tank 46) 55 of the fuel tank 16. The purge pipe 58 can be also connected to the fuel gas emitting pipe 32.

A primary pressure reducing portion 59 is also provided for the primary regulator 56 and a primary atmospheric pressure reference tube 60 is also connected thereto.

Further, as shown in FIG. 1, a secondary pressure reducing portion 61 is provided for the secondary regulator 57 as a low-pressure side regulator and a secondary atmospheric pressure reference tube 62 is also connected thereto. An upstream side gas emitting pipe 63 and a downstream side gas emitting pipe 64 are also connected to the secondary regulator 57 so as to construct the fuel gas emitting pipe 32 with respect to the gas (on the upstream side of the pressure reducing portion) before the pressure reduction and the gas (on the downstream side of the pressure reducing portion) after the pressure reduction in the fuel gas which is reduced by the secondary pressure reducing portion 61, respectively. The fuel gas of a predetermined pressure or more flows in the upstream side gas emitting pipe 63 and the downstream side gas emitting pipe 64, respectively, by the valve opening operation of at the predetermined pressure of a check valve (not shown) provided in the secondary regulator 57. The downstream side of the upstream side gas emitting pipe 63 and the downstream side of the downstream side gas emitting pipe 64 are connected by a confluence connecting portion (union) 65 and connected to the exhaust pipe 26 through a confluence pipe 66 connected to the confluence connecting portion 65 and to the exhaust pipe 26 by a connecting portion (union) 67. That is, the upstream side gas emitting pipe 63 for emitting the hydrogen gas of a high pressure of tens of atmospheric pressure (for example, about 20 atmospheric pressure) is connected to the secondary regulator 57 on the upstream side rather than to the secondary pressure reducing portion 61. On the downstream side, after the secondary pressure reducing portion 61, the downstream side gas emitting pipe 64 for emitting the hydrogen gas of a low pressure of several atmospheric pressure (for example, about 4 to 8 atmospheric pressure) is connected.

As shown in FIG. 3, the upstream side gas emitting pipe or relief pipe 63, downstream side gas emitting pipe 64, and confluence pipe 66 construct the fuel gas emitting pipe 32. In a manner similar to the layout of the primary regulator 56 and the secondary regulator 57, the fuel gas emitting pipe 32 is arranged through the space formed between the front-side fuel tank 45 and the rear-side fuel tank 46 arranged in parallel. The fuel gas emitting pipe 32 is confluence-connected to the exhaust pipe 26 arranged so as to pass along the side of the front-side fuel tank 45 and the rear-side fuel tank 46. The upstream side gas emitting pipe 63 and the downstream side gas emitting pipe 64, forming the fuel gas emitting pipe 32, are assembled along a line which is almost parallel with the first to fourth cross members 36 to 39 of the subframe 33 in the width direction so as to traverse almost the whole subframe 33.

After the upstream side gas emitting pipe 63 and the downstream side gas emitting pipe 64 are extended so as to be independently taken out of the secondary regulator 57, they are joined near the secondary regulator 57 and share the confluence pipe 66 in a range from the confluence connecting portion 65 to the exhaust pipe 26. Thus, the whole length of the pipes is shortened and the complicated pipe assembly is simplified. The upstream side gas emitting pipe 63 and the downstream side gas emitting pipe 64 in a range from the primary regulator 56 and the secondary regulator 57 to the exhaust pipe 26 can be shortened by the arrangement of the primary regulator 56 and the secondary regulator 57. Thus the length of the fuel gas emitting pipe 32 is shortened. The number of portions connected to the exhaust pipe 26 can be also decreased. When the hydrogen gas is emitted by using the exhaust pipes 26 which are partially shared, the hydrogen gas can be substantially emitted by either one of the pipes 63, 64 without simultaneously using both of them.

A defuel pipe which can emit the hydrogen gas is arranged before entering the secondary regulator 57 after the primary regulator 56, thereby enabling the hydrogen gas to be taken out of the defuel coupler 54 on the downstream side of the front-side valve 49 and the rear-side valve 51 of the front-side fuel tank 45 and the rear-side fuel tank 46.

As shown in FIG. 3, the fuel gas emitting pipe 32 is located in an upper half portion of a cross section of the exhaust pipe 26 and almost perpendicularly crosses the exhaust pipe 26. The downstream portion of the exhaust pipe 26 constructing the portions in a range from a slightly upstream side to the downstream edge of the connecting portion of the fuel gas emitting pipe 32 is supported to the subframe 33 and can be separated from the vehicle body together with the subframe 33. Therefore, the upstream side gas emitting pipe 63 and the downstream side gas emitting pipe 64 can be also separated from the vehicle body together with the subframe 33 and the exhaust pipe 26 on the downstream side while maintaining the coupling state.

As shown in FIG. 2, the manifold 27 has a first attaching flange 68 for connecting the exhaust pipe 26, a second attaching flange 69 for connecting the exhaust bypass pipe 30, a first connecting portion 70 for connecting the purge pipe 21, and a second connecting portion 71 for connecting the air bypass pipe 12 so as to confluence-connect the exhaust pipe 26 and the purge pipe 21 on the upstream side. Thus, since the various pipes of the exhaust pipe 26, exhaust bypass pipe 30, purge pipe 21, and air bypass pipe 12 are confluence-connected by the manifold 27, and the air flows from the manifold 27 to the exhaust pipe 26, a light weight, space-saving, and silencing arrangement is accomplished. A curved portion formed on the downstream side results in each pipe being connected to the manifold 27, and the purge pipe 21 having a small cross sectional area is connected to the curved portion.

The reason why the muffler 28 is necessary for the exhaust pipe 26 is as follows. In order to feed the air to the fuel cell 2 so as to perform the power generation at a high efficiency, the air compressor 9 is provided for the air supply pipe 7, thereby pressurizing the air and feeding the pressurized air. Although the operation for pressurizing and feeding the air increases or decreases to a certain extent in dependence on output control of the fuel cell 2, waves of condensation and rarefaction of the fuel gas are caused by the air compressor 9 and such waves are propagated as a sound to a pipeline and are also included in the exhaust gas. It is, therefore, necessary to silence the sound over a band width to a certain extent. By selecting the kind of air compressor 9, a frequency band and a sound volume of the sound can be changed and the sound can be relatively silenced.

Even when the fuel gas is emitted from the fuel gas emitting pipe 32 during an emergency, silencing or a suppression of the exhaust sound can be realized. By constructing so that the sound is silenced after the exhaust sound is suppressed as mentioned above, even if a small muffler whose muffler function has been restricted is used, the exhaust apparatus 6 that can provide sufficient calmness or quiet is constructed. At this time, not only the simple miniaturization, but also excellent maintainability can be assured by the assembling structure according to the simplification of the system.

The shut-off valves 13, 22, 29, and 31 for shutting off the flow of the gas or air or, contrarily, shutting off the backward flow from the downstream side are provided on the upstream side of each of the air bypass pipe 12, purge pipe 21, exhaust pipe 26, and exhaust bypass pipe 30 connected to the manifold 27. Therefore, by a combination of the cross sectional areas of the pipe passages having the different cross sectional areas and opening/closing timing for each shut-off valve, the flow rate can be adjusted within a range from the flow rate based on only one of the pipes to a control form of constant ratio distribution based on a plurality of pipes. In the manifold 27, the gas is also joined with the purge pipe 21 and the purge hydrogen is diluted to a thin concentration by the air and emitted.

While including a middle portion of the exhaust pipe 26, that is, a confluence connecting portion of the purge pipe 21 of the hydrogen gas, the fuel gas emitting pipe 32 is confluence-connected to the exhaust pipe 26 in a range from the confluence connecting portion to the downstream side opening. Further, the muffler 28 is arranged along the path of the exhaust pipe 26 downstream from the confluence connecting portion 67 of the fuel gas emitting pipe 32. The connecting portion 67 of the fuel gas emitting pipe 32 is set to the slightly upstream side position relative to the muffler 28 and it is connected so as to be joined from the upper surface side of the exhaust pipe 26. A boss portion is formed in the coupling portion of the fuel gas emitting pipe 32 and the fuel gas emitting pipe 32 is clamp-fixed and connected by the connecting portion (union) 67.

As shown in FIG. 2, the downstream portion of the exhaust pipe 26 is formed in an almost rectilinear shape. The muffler 28 is provided in the downstream portion of the exhaust pipe 26 serving as a downstream side of the confluence connecting portion 65 with the fuel gas emitting pipe 32. While including the muffler 28, the exhaust pipe 26 is supported near the right-side frame 35 on one side of the subframe 33.

Therefore, since the coupled pipes can be taken down from the vehicle body while keeping the coupling state, there is a convenience in maintainability and ease of replacement. According to the laws and regulations, for example, a consideration is taken to a case where it is necessary to execute an overhaul inspection in which it is necessary to exchange the front-side fuel tank 45 and the rear-side fuel tank 46 every predetermined period or the like, particularly, in a case where it is necessary to take down the front-side fuel tank 45, the rear-side fuel tank 46, and the fuel gas supplying system pipes from the vehicle.

As shown in FIG. 3, the fuel gases which are taken out of each of the front-side fuel tank 45 and the rear-side fuel tank 46 are divided into a plurality of levels to a desired pressure and pressure-reduced by the primary regulator 56 and the secondary regulator 57 and used. The fuel supply pipe 14 which connects the front-side fuel tank 45, rear-side fuel tank 46, primary regulator 56, and secondary regulator 57 is assembled and installed onto the subframe 33. Thus, space-saving can be accomplished and the maintainability can be improved.

As shown in FIG. 3, by using the space formed between the front-side fuel tank 45 and the rear-side fuel tank 46, the primary regulator 56 and the secondary regulator 57 are installed so as to be enclosed into such a space. The second cross member 37 and the third cross member 38 of the subframe 33 are mounted in such a space and are supported and strictly held to a first bracket 72 and a second bracket 73 disposed so as to be built across the second cross member 37 and the third cross member 38, respectively. Parts (lower portions) of the primary regulator 56 and the secondary regulator 57 and the first bracket 72 and the second bracket 73 are mounted so as to be projected downwardly from the subframe 33 and enclosed into a lower space of the subframe 33. A layout of the pipes which are assembled so as to be overlaid over and under the side frame 34, second cross member 37, third cross member 38, and the like of the subframe 33 and are assembled along the extending direction is simplified. Those pipes other than the pipes directly connected to the exhaust pipe 26 are also concentratedly arranged on the side away from the exhaust pipe 26.

As shown in FIG. 2, the exhaust pipe 26 is constructed by: a first hose 74 connected to the downstream side of the manifold 27; a first pipe 75 connected to the first hose 74; a second hose 76 connected to the first pipe 75; a second pipe 77 which is connected to the second hose 76 and has the muffler 28; and a third pipe 79 which is connected to the muffler 28 and has a hydrogen sensor 78. As shown in FIG. 3, the exhaust pipe 26 is arranged under the right-side frame 35 of the subframe 33.

That is, as shown in FIGS. 2 and 3, as for the exhaust pipe 26, a portion including the confluence connecting portion 65 of the fuel gas emitting pipe 32 and the muffler 28 is formed as a downstream side portion. The exhaust pipe 26 is formed with an exhaust pipe portion of the upstream side portion that is separate from the downstream side portion. The exhaust pipe portions of the upstream side portion and the downstream side portion are coupled by the flexible hoses 74 and 76 as separate members while keeping hermetic sealing and water-tightness and are coupled so that they can be divided.

The exhaust pipe 26 is extended toward a vehicle rear or rearmost portion so as to keep the almost horizontal state while meandering or varying in the vehicle width direction so as to avoid a rectilinear shape and to avoid accessories.

The muffler 28 is provided for the exhaust pipe 26 on the slightly upstream side than the downstream side opening. The hydrogen sensor 78 is provided near the downstream side opening of the exhaust pipe 26, thereby managing a concentration of hydrogen which is emitted so that it is equal to a predetermined value (for example, 4%) or less. Thus, the hydrogen sensor 78 attached to the exhaust pipe 26 detects an abnormal state of hydrogen.

The upstream side of the exhaust pipe 26 is strictly fixed and supported to the vehicle body floor at a plurality of positions by clamping and the downstream side is strictly fixed and supported to the subframe 33 at a plurality of positions by clamping.

The confluence connecting portion 67 of the fuel gas emitting pipe 32 for emitting the used fuel gas containing the hydrogen gas is provided on the upstream side of the exhaust pipe 26. While including the confluence connecting portion 67, the exhaust pipe 26 is almost rectilinear in a range from the confluence connecting portion to the downstream side opening serving as its downstream side when seen from the side of the vehicle. Therefore, the exhaust pipe 26 is assembled in a flat shape so that it is uniformly arranged in parallel with the ground or the downstream side is lower than the ground. Thus, in a range from the portion of the exhaust pipe 26 where the hydrogen gas is introduced to the whole downstream portion, the emitting performance of the hydrogen gas can be improved, the residence or accumulation of a large quantity of hydrogen gas can be prevented, and further, the residence or accumulation of the production water can be prevented.

The muffler 28 of a diffusion absorbing type called a high frequency pipe is provided for the exhaust pipe 26. When a flow speed of the gas flowing in the exhaust pipe 26 rises, an abnormal sound in which a specific frequency has been emphasized is generated by a columnar resonance in each pipe which has been confluence-connected to each portion of the exhaust pipe 26. Since, particularly, the high frequency sound is silenced by the muffler 28 provided on the downstream side of the exhaust pipe 26, the silencing performance for the whistle sound which is liable to be generated in the connecting portion of the pipe of the hydrogen gas is improved. According to the silencing effect, the same muffler 28 can be used even for the abnormal sounds of different frequencies and different sound volumes which are generated by a plurality of hydrogen gas pipes.

The muffler 28 is what is called a high frequency pipe and decreases a wind-cutting sound of the air compressor 9, a whistle sound which is generated in the connecting portion or the like of one pipe, or the like. The muffler 28 is constructed in such a manner that an outer tube is provided so as to form a cylindrical space around an inner tube having a number of microholes, and the cylindrical space is filled with a glass wool or the like serving as a sound absorbing material. As an exhaust pipe of the fuel cell 2, axes of the inner tube and outer tube are set into an offset state, thereby realizing a shape having more excellent draining performance.

The muffler 28 is formed in such a manner that with respect to the surface on the side which faces and is close to the ground, a space between the inner tube and the outer tube is set to a minimum value or zero. The inner tube having a number of microholes formed so as to have the single diameter is smoothly connected to the exhaust pipe 26 having the same diameter as that of the inner tube. Thus, the draining performance in the muffler 28 can be improved and the residence or accumulation of the production water can be prevented without obstructing the gas flow. The single muffler 28 can minimize a small amount of residual material or the like remaining in the muffler 28 that is not perfectly or completely ejected.

As shown in FIG. 3, the downstream side portion of the exhaust pipe 26 and the fuel gas emitting pipe 32 of the hydrogen gas are fixedly supported to the subframe 33. The downstream side portion of the exhaust pipe 26 is assembled along the right-side frame 35 as one of the pair of right-side and left-side frames provided on the right and left sides of the subframe 33 and is fixed at a plurality of positions. The fuel gas emitting pipe 32 of the hydrogen gas is arranged along the plurality of cross members 36 to 39 which extend in the vehicle width direction of the subframe 33 and are away from each other in the vehicle front/rear direction, and is fixed at a plurality of positions.

As shown in FIG. 2, the fuel gas emitting pipe 32 of the hydrogen gas is connected to the second pipe 77 on the upstream side of the muffler 28 so as to be branched from the supplying system of the fuel gas.

The fuel gas emitting pipe 32 exhausts the unused fuel gas containing the hydrogen gas and is used for an emergency. Therefore, if some inconvenience occurs, the pipe 32 emits the unused fuel gas containing the hydrogen gas in order to assure the safety as much as possible. Therefore, in the case of performing the emergency emission, there is a case where the emission of the gas, such as hydrogen or the like is continuously executed until the inconvenience or emergency is eliminated.

In the exhaust pipe 26, the downstream side portion including the fuel gas emitting pipe 32 and the muffler 28 can be disconnected from the upstream side portion and removed from the vehicle body together with the subframe 33. At this time, such an operation as to disconnect the connecting portion of the pipes, such as a connecting portion of the downstream side portion of the exhaust pipe 26 and the fuel gas emitting pipe 32 or the like, is unnecessary. Sealing performance can be maintained. The maintenance workability for other parts can be also improved.

That is, the pure hydrogen gas has been emitted to the atmosphere from each pipe in the related art. However, in the embodiment, the hydrogen gas is not emitted to the atmosphere as it is but is joined with the exhaust pipe 26 so as to be diluted and ejected. In the PRD pipe 58 shown in FIG. 1, there is a risk that the emitted powerful pure hydrogen gas flows reversely in the exhaust pipe 26. Since no pressure is applied to each of the atmospheric pressure reference tubes 60 and 62, such a possibility that the exhaust gas flows reversely from the exhaust pipe 26 in the direction of the atmospheric pressure reference tubes 60 and 62 is considered, so that they cannot be connected to the exhaust pipe 26. However, only the fuel gas emitting pipe 32 to which a proper pressure is applied and which does not have the possibility of the backward flow is joined with the exhaust pipe 26, thereby enabling the diluted hydrogen gas to be ejected. In the system in the related art, a pressure relief pipe emits the gas in the vehicle rear direction. However, like a fuel cell system 1 in the embodiment, by connecting to the exhaust pipe 26, the hydrogen gas can be also powerfully emitted in the vehicle rear direction together with the exhaust gas. The abnormality can be also certainly detected by the hydrogen sensor 78 attached to the exhaust pipe 26. Even if such a structure that a check valve (not shown) is used in the regulator 57 and the timing for emitting the fuel gas is individually controlled by the automatic opening operation of the check valve is not used, not only the emitting timing can be managed but also there is no need to individually provide a dedicated hydrogen sensor and a using efficiency of the hydrogen sensor 78 can be improved while reducing the costs.

Therefore, it is possible to provide the exhausting apparatus 6 in which the function for emitting the fuel gas is assured while decreasing an influence on other parts of the vehicle or the like, a consideration is made to the silencing performance and the maintainability, a space-saving and a good mixing efficiency of the exhaust gas are obtained. It is also possible to provide the fuel gas supplying apparatus of the fuel cell system 1 in which the center of gravity can be set to a low position while assuring the suspension function in order to assure the high running performance of the vehicle.

Although the embodiment of the invention has been described above, a construction of the foregoing embodiment is explained as follows.

First, according to the invention, the fuel gas emitting pipe 32 is confluence-connected to the exhaust pipe 26, thereby enabling the fuel gas in the fuel supplying pipe 14 to be temporarily emitted to the atmosphere through the fuel gas emitting pipe 32 and the exhaust pipe 26.

Thus, the fuel gas is not emitted under the vehicle floor near the center of the vehicle. By using the exhaust pipe 26 as a pipe necessary for the function of the fuel cell system 1, the whole pipe layout can be simplified.

According to the invention, the fuel gas emitting pipe 32 is provided for the gas (upstream side of the pressure reducing portion) before the pressure reduction and the gas (downstream side of the pressure reducing portion) after the pressure reduction in the fuel gas whose pressure is reduced by the secondary pressure reducing portion 61 of the secondary regulator 57. Together with the primary and secondary regulators 56 and 57, the fuel gas emitting pipe 32 is supported between the plurality of front-side fuel tank 45 and rear-side fuel tank 46 arranged in the vehicle front/rear direction and is confluence-connected to the exhaust pipe 26 arranged so as to pass along the side of the front-side fuel tank 45 and the rear-side fuel tank 46.

Thus, the fuel gas emitting pipe 32 can be mounted in the space formed between the front-side fuel tank 45 and the rear-side fuel tank 46 and can be arranged in the saved space. While including the fuel supplying pipe 14 extending from the front-side fuel tank 45 and the rear-side fuel tank 46, the pipes of the primary and secondary regulators 56 and 57, the fuel gas emitting pipe 32, the exhaust pipe 26, and the like can be attached/removed to/from the vehicle while keeping the coupling state. The high maintainability can be obtained.

According to the invention, the plurality of primary and secondary regulators 56 and 57 are provided so that the pressure of the fuel gas on the way of the fuel supplying pipe 14 is reduced at a plurality of levels, the upstream side gas emitting pipe 63 and the downstream side gas emitting pipe 64 are connected as a fuel gas emitting pipe 32 to the secondary regulator 57 as a low-pressure side regulator in which the pressure of the fuel gas is lower between the primary and secondary regulators 56 and 57, the upstream side gas emitting pipe 63 and the downstream side gas emitting pipe 64 are connected to the upstream side and the downstream side of the secondary pressure reducing portion 61 of the secondary regulator 57 as a low-pressure side regulator, respectively, and the downstream side of the upstream side gas emitting pipe 63 and the downstream side of the downstream side gas emitting pipe 64 are confluence-connected and, thereafter, connected to the exhaust pipe 26.

Thus, the number of confluence connecting portions of the pipes to the exhaust pipe 26 can be decreased, the noises such as a whistle sound generated in the confluence connecting portion and the like can be decreased, and the sound can be silenced. By concentratedly providing the fuel gas emitting pipe 32 for one secondary regulator 57, the increase in number of branch confluence portions on the pipe layout can be suppressed. Further, by sharing a part of the pipes which are temporarily used, the light weight and the saving-space can be accomplished.

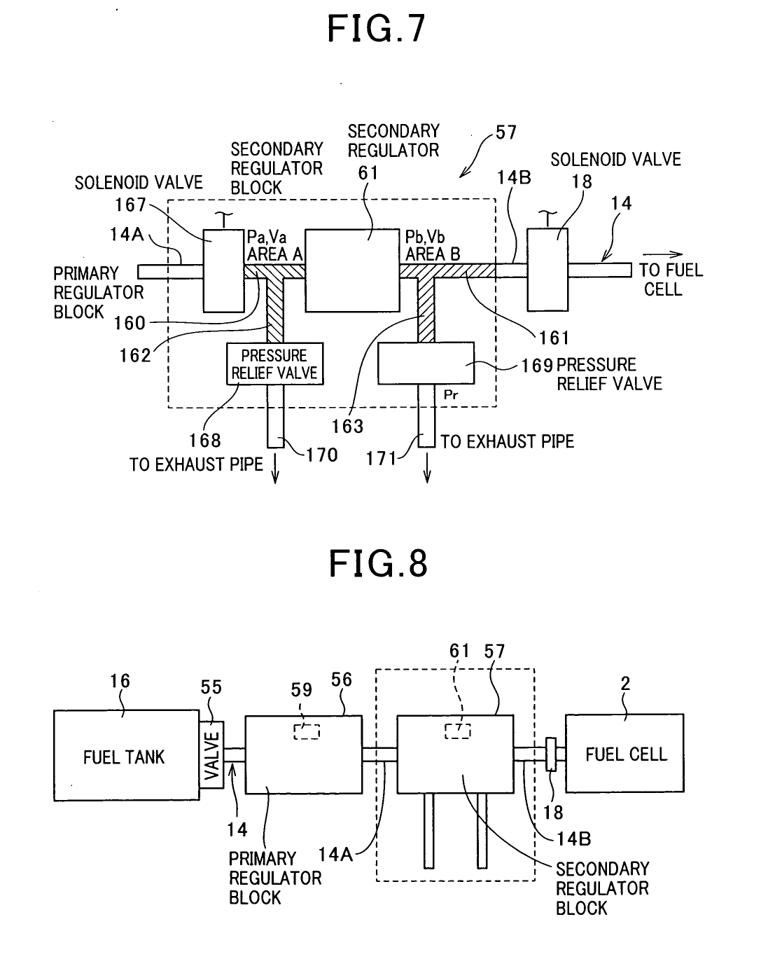

With regard to FIGS. 7-9, reference numerals directed to the same elements as shown in FIGS. 1-4 are not changed. The embodiments of FIGS. 7-9 are operable as part of the arrangements shown in FIGS. 3 and 4.

As shown in the embodiment of FIG. 8, a primary regulator pressure reducing portion 59 is provided for the primary regulator 56. A secondary regulator pressure reducing portion 61 is provided for the secondary regulator 57.

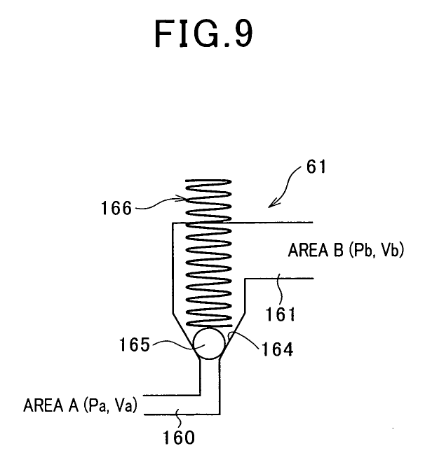

The following passages are formed in the secondary regulator 57 as shown in FIGS. 7 and 9: an upstream side fuel gas passage 160 which is connected to an upstream side fuel supply pipe 14A as a part of the fuelsupply pipe 14 on the upstream side of the secondary regulator pressure reducing portion 61; a downstream side fuel gas passage 161 which is connected to a downstream side fuel supply pipe 14B as a part of the fuel supply pipe 14 on the downstream side of the secondary regulator pressure reducing portion 61; an upstream side relief passage 162 which is branched and connected to the upstream side fuel gas passage 160; and a downstream side relief passage 163 which is branched and connected to the downstream side fuel gas passage 161.

As shown in FIG. 9, the secondary regulator pressure reducing portion 61 has: an opening/closing ball 165 which is arranged between the upstream side fuel gas passage 160 and the downstream side fuel gas passage 161 and can come into contact with or be removed from a ball seating surface 164 so that the upstream side fuel gas passage 160 and the downstream side fuel gas passage 161 are/are not in communication with each other; and a spring 166 as urging means for causing an urging force adapted to urge the opening/closing ball 165 in the closing direction. A set load of the spring 166 is set so as to become the minimum value of the pressure after the reduction.

Further, a high-pressure side solenoid valve 167, as a first solenoid valve, is provided for the secondary regulator 57 on the upstream side fuel gas passage 160 of the secondary regulator pressure reducing portion 61 and at a position near the secondary regulator pressure reducing portion. An upstream side pressure relief valve 168 which can emit the fuel gas to the outside is integratedly provided on the upstream side relief passage 162. Further, a downstream side pressure relief valve 169 which can emit the fuel gas to the outside is integratedly provided on the downstream side relief passage 163. Therefore, the primary regulator 56 is provided as another regulator for the upstream side fuel supply pipe 14A on the upstream side rather than the high-pressure side solenoid valve 167.

The adjusting solenoid valve 18, as a second solenoid valve, is provided for the downstream side fuel supply pipe 14B connected to the downstream side of the secondary regulator pressure reducing portion 61.

An upstream side relief pipe 63 and a downstream side relief pipe 64 are connected to the upstream side relief passage 162 and the downstream side relief passage 163, respectively, so as to construct the fuel gas emitting pipe 32. As illustrated in FIG. 3, the upstream side relief pipe 63 and the downstream side relief pipe 64 are joined in a confluence connecting portion (union) 65 and are coupled with a confluence pipe 66 connected to the confluence connecting portion 65. A front edge of the confluence pipe 66 is connected to the exhaust pipe 26 by a connecting portion (union) 67. Thus, the fuel gas which is emitted from the fuel gas emitting pipe 32 constructed by the upstream side relief pipe 63, downstream side relief pipe 64, and confluence pipe 66 is not directly emitted to the atmosphere, but is diluted by the air (off-gas) in the exhaust pipe 26 and, thereafter, emitted.

In the structure as mentioned above, by closing the high-pressure side solenoid valve 167 as a first solenoid valve and the adjusting solenoid valve 18 as a second solenoid valve, as shown in FIG. 7, the flow of the fuel gas which circulates in the upstream side fuel gas passage 160, downstream side fuel gas passage 161, and downstream side fuel supply pipe 14B is shut off, a capacity area is formed between the high-pressure side solenoid valve 167 and the adjusting solenoid valve 18. Specifically speaking, when the high-pressure side solenoid valve 167 and the adjusting solenoid valve 18 are closed, an upstream side capacity area (hereinbelow, referred to as “area A”) which is formed by the upstream side fuel gas passage 160 in a range from the high-pressure side solenoid valve 167 to the secondary regulator pressure reducing portion 61 and a downstream side capacity area (hereinbelow, referred to as “area B”) which is formed by the downstream side fuel gas passage 161 and the downstream side fuel supply pipe 14B in a range from the secondary regulator pressure reducing portion 61 to the adjusting solenoid valve 18 are formed.

In the embodiment shown in FIG. 7, a pressure at which the area A and the area B have been set into a pressure equilibrium state is set so as to be lower than a set pressure of the downstream side pressure relief valve 169 in the area B.

As shown in FIG. 9, in the secondary regulator pressure reducing portion 61, the internal upstream side fuel gas passage 160 and downstream side fuel gas passage 161 are formed so that their cross sectional areas, passage diameters, and the like are obtained at high precision by a drill work or the like because the regulator function is important.

The high-pressure hydrogen gases (for example, about maximum 100 to 700 atmospheric pressure) taken out of tank-built-in valves of a plurality of fuel tanks 45 and 46 are introduced by the joined fuel supply pipe 14 to the primary regulator 56 mounted near the center in the vehicle width direction. The hydrogen gases are remarkably reduced by the primary regulator 56 and are taken out at tens of atmospheric pressure (for example, about 20 atmospheric pressure (middle pressure)). Subsequently, the fuel gas of such a middle pressure is introduced by the fuel supply pipe 14 to the secondary regulator 57 arranged on the side of the primary regulator 56 (valve side of the tank unit 15). The fuel gas is secondarily pressure-reduced by the secondary regulator 57 and taken out a few atmospheric pressure (for example, about 4 to 8 atmospheric pressure (low pressure)). The fuel gas is further supplied to the anode side of the fuel cell 2 on the downstream side by the fuel supply pipe 14.

As shown in FIG. 7, the high-pressure side solenoid valve 167 as a first solenoid valve is provided on the way of the fuel supplying passage connecting the primary regulator pressure reducing portion 59 in the primary regulator 56 and the secondary regulator pressure reducing portion 61 in the secondary regulator 57. The shut-off of the circulation of the fuel gas in the whole fuel supplying passage can be roughly controlled by the high-pressure side solenoid valve 167. When the fuel cell 2 is operated, the high-pressure side solenoid valve 167 and the adjusting solenoid valve 18 are opened so as to allow the fuel gas to circulate. When the vehicle stops or an inconvenience such as an abnormal pressure or the like has occurred, the high-pressure side solenoid valve 167 and the adjusting solenoid valve 18 are closed so as to shut off the fuel gas.

The adjusting solenoid valve 18 and the high-pressure side solenoid valve 167 are connected to control means and are driven by the control means.

The upstream side relief passage 162 and downstream side relief passage 163 serving as passages for emission are provided in the secondary regulator 57 so as to be branched from the upstream side fuel gas passage 160 and downstream side fuel gas passage 161 serving as supplying passages of the fuel gas. The upstream side relief pipe 63 and downstream side relief pipe 64 serving as emergency emitting pipes for emitting the unused fuel gas containing the hydrogen gas are provided out of the secondary regulator 57.

As shown in FIG. 7, the upstream side pressure relief valve 168 and the downstream side pressure relief valve 169 are provided for the upstream side relief passage 162 and the downstream side relief passage 163. The upstream side pressure relief valve 168 and the downstream side pressure relief valve 169 are mechanical valves which are automatically opened when pressures of the upstream side relief passage 162 and downstream side relief passage 163 serving as internal passages rise to set pressures or more. Since the upstream side pressure relief valve 168 and the downstream side pressure relief valve 169 are used for emergency, if some inconvenience occurred, they emit the unused fuel gas containing the hydrogen gas. Therefore, in the case of performing an emergency emission, since the inconvenience is eliminated, the emission of the gas, such as hydrogen, is continuously performed.

A capacity (volume) of the passage is set in each of the upstream side relief passage 162 and downstream side relief passage 163 serving as an internal passage of the secondary regulator 57.

That is, as shown in FIG. 7, in the related art, in the secondary regulator 57, even after the high-pressure side solenoid valve 167 closes, the regulator cannot be perfectly sealed in terms of the structure of the secondary regulator pressure reducing portion 61 and a small amount of gas leaks. Therefore, the pressure in the area A (the volume of the regulator primary side internal passage) cannot be perfectly stopped. That is, the pressure in the area B rises little by little due to such a creep phenomenon that the hydrogen gas flows gradually into the area B (the volume of the regulator secondary side internal passage+the volume of the pipe to the adjusting solenoid valve 18). There is such a drawback that when the pressure in the area B rises to a predetermined value or more of the pressure of the downstream side pressure relief valve 169, the hydrogen gas which ought to have inherently been supplied to the battery cell 2 from the downstream side pressure relief valve 169 of the secondary regulator 57 is wastefully emitted.

Therefore, in the embodiment, after the high-pressure side solenoid valve 167 is closed, even if the high pressure hydrogen gas in the area A flows to the area B (leakage operation is permitted). So long as the pressure in the area B does not exceed the set value of the downstream side pressure relief valve 169, the hydrogen gas is not emitted from the downstream side pressure relief valve 169 to the outside of the fuel apparatus 4.

It is, therefore, presumed that the pressure in the area A (pressure reduced by the primary pressure reducing portion 59) is equal to Pa, its volume is equal to Va, the pressure in the area B (pressure reduced by the secondary pressure reducing portion 61) is equal to Pb, its volume is equal to Vb, a pressure in the case where the pressure in the area A and the pressure in the area B are set to a uniform pressure due to the creep phenomenon (when the pressure in the area B becomes maximum) is equal to P, and an emission set pressure of the downstream side pressure relief valve 169 is equal to Pr.

At this time, by applying a Boyle-Charles' law in the states before and after the creep phenomenon, the following equation is satisfied.

(Pa*Va+Pb*Vb)=P*(Va+Vb)

Therefore, since the pressure P can be expressed as follows,

P=(Pa*Va+Pb*Vb)/(Va+Vb)

if the apparatus is designed in such a manner that the pressure P is smaller than the set pressure Pr of the downstream side pressure relief valve 169, the hydrogen gas is not emitted from the downstream side pressure relief valve 169.

For example, in the state where the adjusting solenoid valve 18 and the high-pressure side solenoid valve 169 are closed, assuming that Pa=5 (MPa), Pb=1 (MPa), Pr=2*Pb, and Va=100 (cubic centimeter), it is sufficient to satisfy the following expression.

P=(Pa*Va+Pb*Vb)/(Va+Vb)<Pr

Therefore, since

(5*100+1*Vb)/(100+Vb)<2,

a condition of Vb is set to 300 (cubic centimeter) or more.

Thus, if the apparatus is designed in such a manner that the volume of Vb is equal to 300 (cubic centimeter) or more, such a phenomenon that the hydrogen gas is emitted from the downstream side pressure relief valve 169 by the creep phenomenon is eliminated.

After the set pressure of the downstream side pressure relief valve 169 is set to a value which is a predetermined number of times larger than the set pressure after completion of the pressure reduction of the secondary pressure reducing portion 61, the capacity (volume) of the area B is set to be sufficiently larger than that of the area A, thereby obtaining a fundamental construction.

While a predetermined capacity is as small as possible in the internal passage of the secondary pressure reducing portion 61 corresponding to the area A, a predetermined capacity is assured in the internal passage (gas passage) of the secondary pressure reducing portion 61 corresponding to the area B, and a large capacity is assured by the external pipe (fuel supplying pipe) of the secondary pressure reducing portion 61 corresponding to the area B. As an effect, the capacity of the area B can be assured without strictly limiting a length of pipe to the adjusting solenoid valve 18 and the emission of the hydrogen gas from the downstream side pressure relief valve 169 can be certainly prevented. Since there is no need to pay attention to the length of pipe to the adjusting solenoid valve 18, the pipe layout can be easily performed. Since the secondary pressure reducing portion 61 can be decreased in size, the secondary pressure reducing portion 61 can be mounted in a compact size by using the space formed between the fuel tanks 45 and 46.

As shown in FIG. 7, the inside of the upstream side(area A) of the secondary pressure reducing portion 61 has branch passages and the upstream side pressure relief valve 168 is provided for one of the branch passages. Since the upstream side of the secondary pressure reducing portion 61 is set to the middle pressure, the set pressure at which the upstream side pressure relief valve 168 operates is set to a surplus pressure higher than the operating pressure of the secondary pressure reducing portion 61. If the set pressure of the upstream side pressure relief valve 168 is too high, a width of supplying pressure of the fuel gas which is supplied to the secondary pressure reducing portion 61 increases and the pressure after completion of the pressure reduction on the downstream side of the secondary pressure reducing portion 61 fluctuates due to an influence of such a pressure change. On the contrary, if the set pressure is too low, since the unused fuel gas is emitted, an amount of fuel gas which is wastefully consumed increases. It is, therefore, preferable to set such a pressure with a proper allowance.

Although the upstream side pressure relief valve 168 in the area A has been arranged on the downstream side of the high-pressure side solenoid valve 167 as a first solenoid valve in the FIG. 7 embodiment, for example, it can also be arranged on the upstream side of the high-pressure side solenoid valve 167. In this case, the capacity of the area A can be decreased more and, by decreasing the pressure at the time when the pressure equilibrium state has been obtained, it can approach the set value (downstream side pressure) after completion of the pressure reduction of the secondary pressure reducing portion 61 and a setting range of the upstream side pressure relief valve 168 can be widened. In the internal structure of the secondary regulator 57, the pipe layout of the internal passage corresponding to the area B to the downstream side pressure relief valve 169 corresponding to the area B can be extended. In such a case, a limitation of the length (such a condition that it is equal to a predetermined length or more) of pipe which is connected as a fuel supply pipe 14 can be reduced.

As illustrated in FIG. 3, after the upstream side relief pipe 63 and the downstream side relief pipe 64 are extended so as to be independently taken out of the secondary pressure reducing portion 61, they are joined near the secondary pressure reducing portion. The confluence pipe 66 in a range from the joint portion of the upstream side relief pipe 63 and the downstream side relief pipe 64 to the exhaust pipe 26 is shared. By this structure, the whole length of pipe is shortened and the complicated pipe assembly is simplified. The length of pipe from the secondary pressure reducing portion 61 to the exhaust pipe 26 can be shortened by such a layout of the secondary pressure reducing portion and the number of connecting portions to the exhaust pipe 26 can be decreased. When emitting the hydrogen gas by using the pipes in which a part of them is shared, the hydrogen gas is substantially emitted by either one of the pipes without simultaneously emitting the gas from both of the pipes.

As shown in FIG. 7, by integrating the high-pressure side solenoid valve 167 as a first solenoid valve and a plurality of pressure relief valves 168 and 169 into the secondary regulator 57 as mentioned above, the capacity of the area A as an internal passage of the upstream side of the secondary pressure reducing portion 61 can be set to a value which is sufficiently smaller than that of the area B constructed by the internal passage of the downstream side of the secondary pressure reducing portion 61 and the pipe on the downstream side of the secondary regulator 57. Even if the pressures are shifted to the pressure equilibrium state in the secondary pressure reducing portion 61, the emission of the hydrogen gases from the pressure relief valves 168 and 169 which are directed to the area B can be prevented.

The downstream side fuel supply pipe 14B is connected as a fuel supplying passage on the downstream side of the secondary regulator 57. The adjusting solenoid valve 18 as a second solenoid valve is provided on the downstream side where the downstream side fuel supply pipe 14B has been extended.

The adjusting solenoid valve 18 can control the shut-off of the circulation of the fuel gas at high precision. When the fuel cell 2 is operated, the adjusting solenoid valve 18 is opened so that the fuel gas circulates. When the vehicle stops or an inconvenience such as an abnormal pressure or the like has occurred, the adjusting solenoid valve 18 is closed so as to shut off the fuel gas.

Therefore, the capacity areas for storing the shut-off fuel gas can be specified by the two solenoid valves 18 and 167 and the upstream/downstream side fuel supply pipes 14A and 14B including the secondary pressure reducing portion 61, and a range where the pressure propagation due to the penetration of the secondary pressure reducing portion 61 spreads can be restricted.

A plurality of adjusting solenoid valves 18 can also be provided. The fuel supplying passage on the downstream side is branched and coupled with the anode of the fuel cell 2, respectively. In the normal operating mode of the fuel cell 2, while the opening and closing operations are periodically repetitively performed, the adjusting solenoid valves 18 operate synchronously so that the mutual timing differs. By such a construction, the hydrogen gas as a fuel gas is uniform and supplied to the fuel cell 2.

A function for emitting the hydrogen gas to the outside of the system (here, the internal passage of the exhaust pipe 26 for emitting the exhaust gas containing a large quantity of cathode off-gas which is emitted from the cathode of the fuel cell 2) is provided. Such a function is roughly classified into the purge and the emergency emission and their objects and roles differ. The purge function is provided for the emitting passage from the anode of the fuel cell 2 and is used mainly for improving a reaction efficiency of the fuel cell 2. The emergency emission function is provided for the fuel supplying system and is used mainly for assuring the proper processes when some abnormality has occurred.

In the embodiment shown in FIG. 9, for example, the apparatus is a type in which the pressure in the area B is used as a pilot pressure and a back pressure is applied to the spring 166 by a diaphragm or the like. In the case where the pressure in the area B rises gradually, the pressure is made difficult to rise by an amount corresponding to a capacity of a diaphragm chamber. When the pressure rises, the spring 166 pushes the opening/closing ball 165 in the closing direction. Therefore, a time that is required until the downstream side pressure relief valve 169 is made operative can be also extended (delayed).

Although the embodiment of the invention has been described above, a construction of the foregoing embodiment will be explained in detail as follows.

First, according to the embodiment shown in FIG. 7, the solenoid valve 167 and the plurality of pressure relief valves 168 and 169 are integratedly provided for the regulator 57 having the pressure reducing portion 61, the solenoid valve 167 is arranged on the upstream side fuel gas passage 160 of the pressure reducing portion 61 and at the position near the pressure reducing portion 61. A pressure relief valve 168 is connected to the upstream side fuel gas passage 160 of the pressure reducing portion 61, and the other pressure relief valve 169 is connected to the downstream side fuel gas passage 161 of the pressure reducing portion 61.

Thus, the capacity area which is formed by upstream side fuel gas passage 160 in the range from the pressure reducing portion 61 to the solenoid valve 167 can be decreased, and the volume of the fuel gas of the pressure (middle pressure), which is sufficiently higher than the pressure (low pressure) on the downstream side of the pressure reducing portion 61, can be suppressed to a small value. Even if the penetration of the fuel gas in the pressure reducing portion 61 using the mechanical valve occurred, the influence of the pressure propagation can be reduced as much as possible.

According to another embodiment of the invention, the upstream side fuel supply pipe 14A is connected to the regulator 57 on the upstream side at the first solenoid valve 167, the downstream side fuel supply pipe 14B connects to the regulator 57 on the downstream side at the pressure reducing portion 61. The primary regulator 56, different from the regulator 57, is provided for the upstream side fuel supply pipe 14A. The second solenoid valve 18 is provided for the downstream side fuel supply pipe 14B, and the flow of the fuel gas which circulates in the upstream side fuel gas passage 160, the downstream side fuel gas passage 161, and the downstream side fuel supply pipe 14B is shut off by closing the first solenoid valve 167 and the second solenoid valve 18, thereby forming the capacity area between the first solenoid valve 167 and the second solenoid valve 18.

Thus, the capacity areas for storing the shut-off fuel gas can be specified by the two solenoid valves 167 and 18 and the upstream side fuel gas passage 160 and downstream side fuel gas passage 161 including the pressure reducing portion 61, and the range where the pressure propagation due to the penetration of the pressure reducing portion 61 can be restricted.

According to another embodiment of the invention, the pressure at which the upstream side capacity area (area A) that is formed by the upstream side fuel gas passage 160 in the range from the first solenoid valve 167 to the secondary regulator pressure reducing portion 61, when the first solenoid valve 167 and the second solenoid valve 18 have been closed and the downstream side capacity area (area B) that is formed by the downstream side fuel gas passage 161 and the downstream side fuel supply pipe 14B in the range from the pressure reducing portion 61 to the second solenoid valve 18 have been set into the pressure equilibrium state so as to be lower than the set pressure of the other pressure relief valve 169 in the downstream side capacity area (area B).

Thus, even if there is a leakage operation which the pressure reducing portion 61 essentially has, it is possible to prevent the function of the pressure relief valve 169 from being made operative and such a situation that the unused fuel gas (hydrogen) is wastefully emitted can be eliminated.

The fuel cell system according to these embodiments of the invention can also be applied to another system using the regulator.

The fuel cell system according to the invention can be applied to various kinds of vehicles of other gas fuel as well as hydrogen.

We claim:

1. A fuel gas supplying apparatus of a fuel cell system comprising: a fuel cell for supplying air containing oxygen to a cathode, supplying a fuel gas containing hydrogen to an anode, and executing a power generation; an exhaust apparatus having a muffler in an exhaust pipe on a downstream side of said fuel cell; a fuel apparatus having a fuel supply pipe for supplying the fuel gas to said fuel cell and a regulator which is arranged on the way of said fuel supply pipe for reducing pressure of the fuel gas; and a fuel gas emitting pipe for emitting fuel gas in said fuel supply pipe to an outside of said fuel apparatus, wherein said fuel gas emitting pipe is confluence-connected to said exhaust pipe, thereby enabling the fuel gas in said fuel supply pipe to be temporarily emitted to the atmosphere through said fuel gas emitting pipe and said exhaust pipe.

2. The fuel gas supplying apparatus of the fuel cell system according to claim 1, wherein said fuel gas emitting pipe is provided for the gas before the pressure reduction and the gas after the pressure reduction in the fuel gas whose pressure is reduced by a pressure reducing portion of said regulator, and together with said regulator, said fuel gas emitting pipe is supported between a plurality of fuel tanks arranged in a vehicle front/rear direction and is confluence-connected to said exhaust pipe arranged so as to pass along a side of each of said fuel tanks.

3. The fuel gas supplying apparatus of the fuel cell system according to claim 2, wherein a plurality of said regulators are provided so that the pressure of the fuel gas on the path of said fuel supply pipe is reduced at a plurality of levels, an upstream side gas emitting pipe and a downstream side gas emitting pipe are connected as said fuel gas emitting pipe to a low-pressure side of a first low pressure side said regulator in which the pressure of the fuel gas is lower than at another second said regulator, wherein said upstream side gas emitting pipe and said downstream side gas emitting pipe are connected to an upstream side and a downstream side of said pressure reducing portion of said low-pressure side regulator, respectively, and the downstream side of said upstream side gas emitting pipe and the downstream side of said downstream side gas emitting pipe are confluence-connected and, thereafter, connected to said exhaust pipe.

4. A fuel gas supplying apparatus for a fuel cell system comprising: a fuel cell for receiving air containing oxygen at a cathode, receiving a fuel gas containing hydrogen at an anode, and executing a power generation; an exhaust apparatus having a muffler in an exhaust pipe on a downstream side of said fuel cell; and a fuel apparatus having a fuel supply pipe for supplying the fuel gas to said fuel cell, in which a regulator pressure reducing portion reduces a pressure of the fuel gas, a solenoid valve for controlling a shut-off of circulation of the fuel gas, and a pressure relief valve for emitting the fuel gas to an outside of said fuel apparatus are arranged on a passage of said fuel supply pipe, wherein said solenoid valve and a plurality of pressure relief valves are integratedly provided for a regulator having said pressure reducing portion, said solenoid valve is provided on an upstream side fuel gas passage of said pressure reducing portion, one of said pressure relief valves is connected to said upstream side fuel gas passage of said pressure reducing portion, and the other pressure relief valve is connected to a downstream side fuel gas passage of said pressure reducing portion.

5. The fuel gas supplying apparatus for the fuel cell system according to claim 4, wherein an upstream side fuel supply pipe is connected to said regulator on an upstream side and to a said solenoid valve comprising a first said solenoid valve, a downstream side fuel supply pipe is connected to said regulator on a downstream side of said pressure reducing portion, a second regulator different from said first regulator is provided for said upstream side fuel supply pipe, a second solenoid valve is provided for said downstream side fuel supply pipe, and a flow of the fuel gas which circulates in said upstream side fuel gas passage, said downstream side fuel gas passage, and said downstream side fuel supply pipe is shut off by closing said first solenoid valve and said second solenoid valve, thereby forming a capacity area between said first solenoid valve and said second solenoid valve.

6. The fuel gas supplying apparatus for the fuel cell system according to claim 5, wherein a pressure at which an upstream side capacity area that is formed by said upstream side fuel gas passage in a range from said first solenoid valve to said regulator pressure reducing portion when said first solenoid valve and said second solenoid valve close and a downstream side capacity area formed by said downstream side fuel gas passage and said downstream side fuel supply pipe in a range from said regulator pressure reducing portion to said second solenoid valve have been set into a pressure equilibrium state so as to be lower than a set pressure of said other pressure relief valve in said downstream side capacity area.
